(19) United States
(12) Patent Application Publication
(10) Pub. No.: US 2005/0138068 A1
(43) Pub. Date: Jun. 23, 2005

(54) Configuration editing

(76) Inventors: Greg Wilbur, Ottawa (CA); John Afaganis, Fort Saskatchewan (CA); Lori-Ann McGrath, Kanata (CA)

Correspondence Address: WITHROW & TERRANOVA, P.L.L.C., P.O. BOX 1287, CARY, NC, 27512, US

(21) Appl. No.: 10/739,888

(22) Filed: Dec. 17, 2003

(51) Int. Cl. G06F 17/00

(52) U.S. Cl. 707/104.1

(57) ABSTRACT

In one aspect a system and method includes receiving user-input configuration changes to a configuration file and tracking the configuration changes in multiple independent edit views. The method also includes updating an active-edit view to include configuration changes of a single independent edit view, and updating a configuration database that stores the configuration files, according to configuration changes in the active edit view.

### BACKGROUND

In computers and computer networks, configuration data often refers to specific hardware and software details for a computer system or network. These details can include what devices are connected to the network, capacities and capabilities of the devices, topology of the network, and the like. Configuration data is often stored in a configuration database that includes a detailed record of the information describing the systems and the network. A user modifies and updates the configuration database to include changes in the configuration of the system.

### SUMMARY

In one aspect a system and method includes receiving user-input configuration changes to a configuration file and tracking the configuration changes in multiple independent edit views. The method also includes updating an active edit view to include configuration changes of a single independent edit view, and updating a configuration database that stores the configuration files, according to configuration changes in the active edit view.

Embodiments may include one or more of the following. The method can include checking the syntax and semantics of the active edit view before updating the configuration database. The method can include updating other independent edit views based on changes in the active edit view.

The method can include generating a list of changes to the configuration file in the configuration database based on the updating of the configuration database. The method can include identifying conflicts between an independent edit view and the list of changes. A conflict can include any modification to an element included in both the list of changes to the configuration files in the configuration database and an independent edit view. The method can include resolving the conflict between the independent edit view and the list of changes. Resolving the conflict can include updating the independent edit view based on the active edit view such that the independent edit view includes the changes to the configuration database, discarding the changes in the active edit view and applying a different independent edit view to the active edit view, or resolving conflicts on an individual basis.

In another aspect, a computer program product, tangibly embodied in an information carrier, for executing instructions on a processor can cause a machine to receive user-input configuration changes to a configuration file. The computer program product causes the machine to track the configuration changes in multiple independent edit views, update an active edit view to include configuration changes of a single independent edit view, and update a configuration database that stores the configuration file, according to configuration changes in the active edit view.

Embodiments may include one or more of the following. The computer program product can check the syntax and semantics of the active edit view before updating the configuration database. The computer program can update other independent edit views based on changes in the active edit view. The computer program can generate a list of changes to the configuration file in the configuration database based on the updating of the configuration database. The computer program product can identify conflicts between an independent edit view and the list of changes. The computer program product can resolve the conflict between the independent edit view and the list of changes.

In another aspect, an article of manufacture can be configured to receive user-input configuration changes to a configuration file, track the configuration changes in multiple independent edit views, update an active edit view to include configuration changes of a single independent edit view, and update a configuration database that stores the configuration file, according to configuration changes in the active edit view.

Embodiments may include one or more of the following. The article of manufacture can check the syntax and semantics of the active edit view before updating the configuration database. The article of manufacture can update other independent edit views based on changes in the active edit view. The article of manufacture can generate a list of changes to the configuration file in the configuration database based on the updating of the configuration database. The article of manufacture can identify and resolve conflicts between an independent edit view and the list of changes.

The use of independent edit sessions allows multiple users to concurrently edit configuration data. Multiple users edit configuration data in independent edit sessions that track a list of changes a user makes to the configuration database. Since the independent edit sessions are not a full copy of the configuration database, but only a record of proposed changes the amount of memory needed to support multiple edit sessions is reduced. The reduced information held for each edit session allows the independent edit sessions to be swapped into the active edit view giving real-time support of concurrency for a number of parallel users. Using a reduced amount of memory per user also allows more users to be supported within for a particular amount of memory thus, increasing the number of concurrent users in a given memory space. The reduced memory requirement also allows the system to be supported in main memory providing better performance.

Tracking of changes in the independent edit view also simplifies identifying and resolving conflicts between an updated version of the configuration database and an independent edit session. The system generates a list of changes when the configuration database is updated. The system identifies changes to common elements between the list of changes in the independent edit views and the list of changes applied to the configuration database. This reduces the time to detect and resolve conflicts since the proposed changes in the independent edit views are compared only to the changes applied to the configuration database and not to the entire database.

### DESCRIPTION OF DRAWINGS

FIG. 1 is a diagram of a configuration database and multiple computer systems.

FIG. 2 is a diagram depicting relationships between the configuration database, active edit view, current view, and edit sessions.

FIG. 3 is a flow chart of a process to update the configuration database.

FIGS. 4A-C are flow charts of processes for resolving conflicts between an independent edit view and a current edit view.

### DESCRIPTION

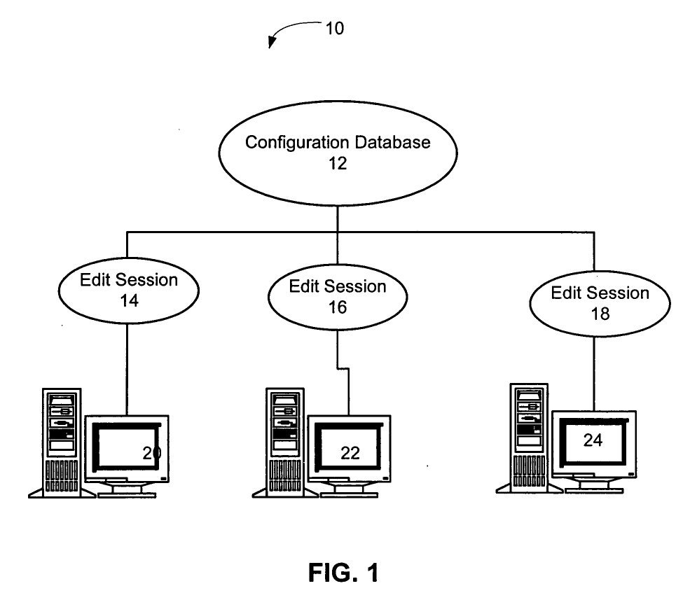

Referring to FIG. 1, a system 10 for editing configuration data includes a configuration database 12, multiple edit sessions 14, 16, and 18, and multiple terminals 20, 22, and 24. The configuration database 12 includes configuration data specifying specific hardware and software details for a particular system or network. For example, if the system includes Internet Protocol (IP) routing information. A user might decide to add an additional port to a router. To add the new port, a user updates the configuration database 12 and configures the new port to be an IP interface. In this particular example, updates to the configuration database 12 might include specifying a port identifier, IP address, or a switching protocol for the new port.

The configuration database 12 can include a large amount of configuration data and it can be advantageous for multiple users (e.g., users of systems 20, 22, and 24) to edit the configuration data concurrently using edit sessions (e.g., edit sessions 14, 16, and 18). However, when multiple users edit the configuration data at the same time, conflicts can arise between the edits of the different users. A conflict can include any addition, modification, or deletion of a common element between the multiple users. For example, a conflict would arise if two ports were assigned the same unique identifier.

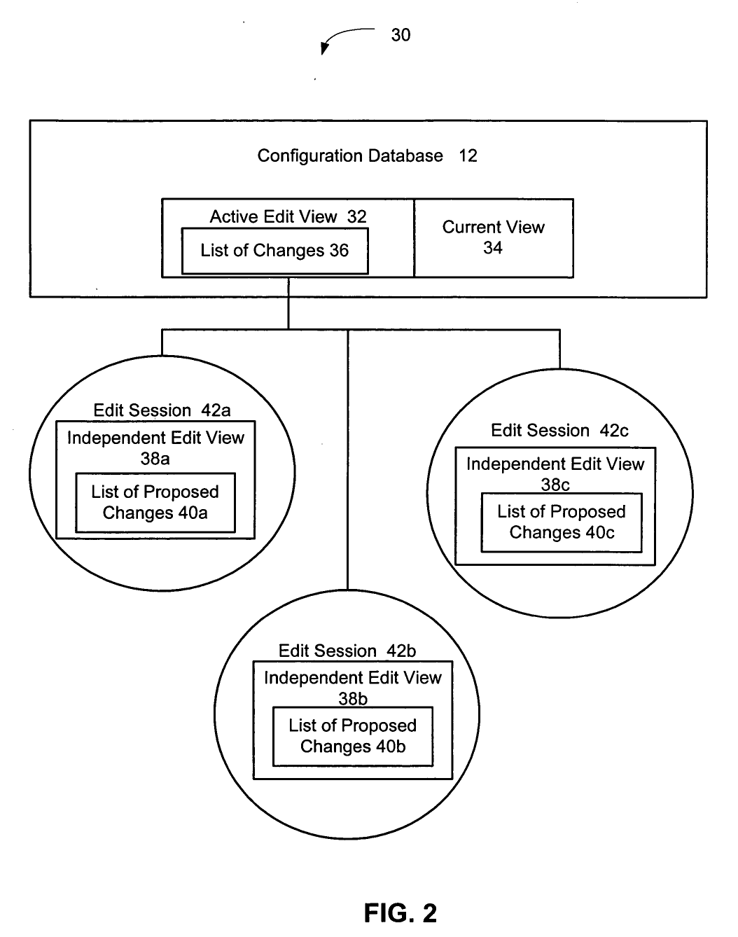

Referring to FIG. 2, a system 30 allows multiple users to edit configuration data in the configuration database 12 concurrently. System 30 includes a configuration database 12 and an associated active edit view 32 and current view 34. The active edit view 32 tracks proposed configuration changes for a single edit session 42 in a list of changes 36. Multiple users edit the configuration database concurrently using individual edit sessions (e.g., edit sessions 42a, 42b, and 42c). Each edit session 42 is associated with an independent edit view 38a, 38b, and 38c that includes a list of proposed changes 40a, 40b, and 40c to the configuration database 12. In one example, user initiates an edit session 42 and the session tracks the changes on a central processor and memory and not on the user's individual station. To apply updates to the configuration database 12, a user submits changes in the independent edit view 38 such that their particular independent edit view 38 becomes the active edit view 32. Only changes in the active edit view 32 are applied to the configuration database 12.

The active edit view 32 and the independent edit views 38 need not be a complete copy of the configuration database 12, but instead include a proposed list of changes 36. The current view 34 includes a most recent version of the configuration database changes and includes a list of previously applied changes to the configuration database 12. An edit in the active edit view 32 is semantically checked and applied to the configuration database 12 as a single transaction.

Since multiple users concurrently edit the configuration database using multiple independent edit views 38, changes applied to the configuration database 12 by one user may conflict with the changes in another user's list of proposed changes 40. To resolve conflicts a user of a particular edit session 38 accepts the current view 34 version of the database, applies their own edit view version, or resolves the conflicts on an individual basis.

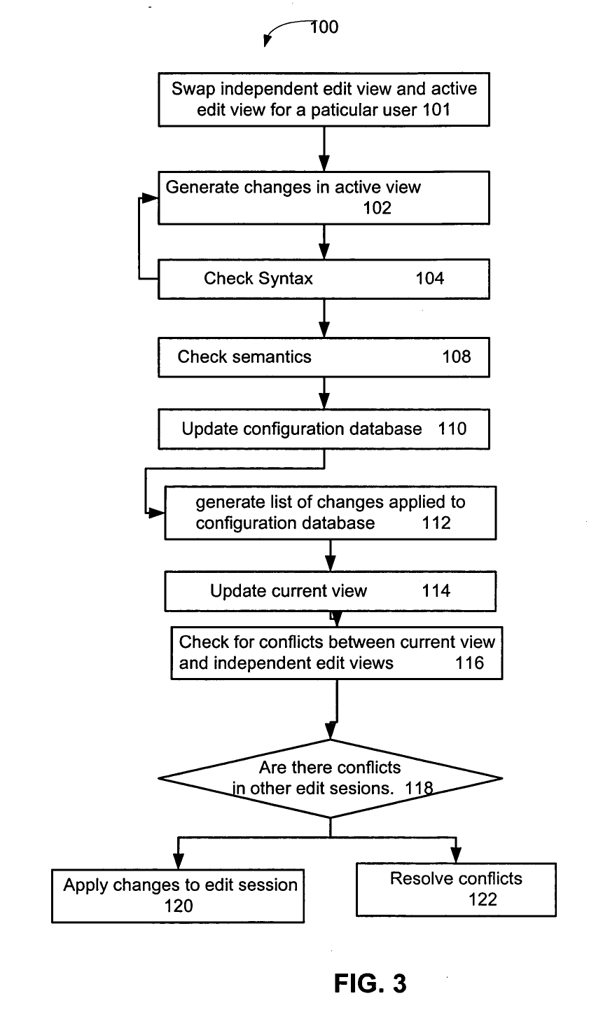

Referring to FIG. 3, a process 100 for updating the configuration database 12 is shown. Process 100 includes swapping 101 a particular independent edit view and the active edit view. The swapping of the views effectively moves a particular user into an “active” status from a “waiting” status. Process 100 tracks 102 configuration changes in the active edit view and checks 104 the syntax of the configuration data changes as the changes are entered.

For example, if a particular type of configuration entry is limited to a numerical range of 0-100 and the configuration data specifies a numerical value of 1000 an error would be returned. The active edit view 32 includes a list of the changes and checks 108 the semantics of the configuration data. For example, the validation that any references to other objects in the configuration database are valid and defined e.g. Class-of-Service Profile.

If the semantics of the configuration changes are correct, process 100 updates 110 the configuration database 12 with the changes in the active edit view 32. Upon successfully updating the configuration database 12, process 100 generates 112 a list of changes applied to the configuration database 12. Process 100 also updates 114 the current view 34 to include the changes to the configuration database 12. Process 100 checks 116 for conflicts between the current view 34 and the multiple other independent edit views 38 and determines 118 if conflicts exist. If no conflicts exist between the independent edit views 38 and the current view 34, process 100 applies 120 the changes to the edit session. If conflicts exist, process 100 resolves 122 the conflicts between the independent edit views 38 and the current view 34.

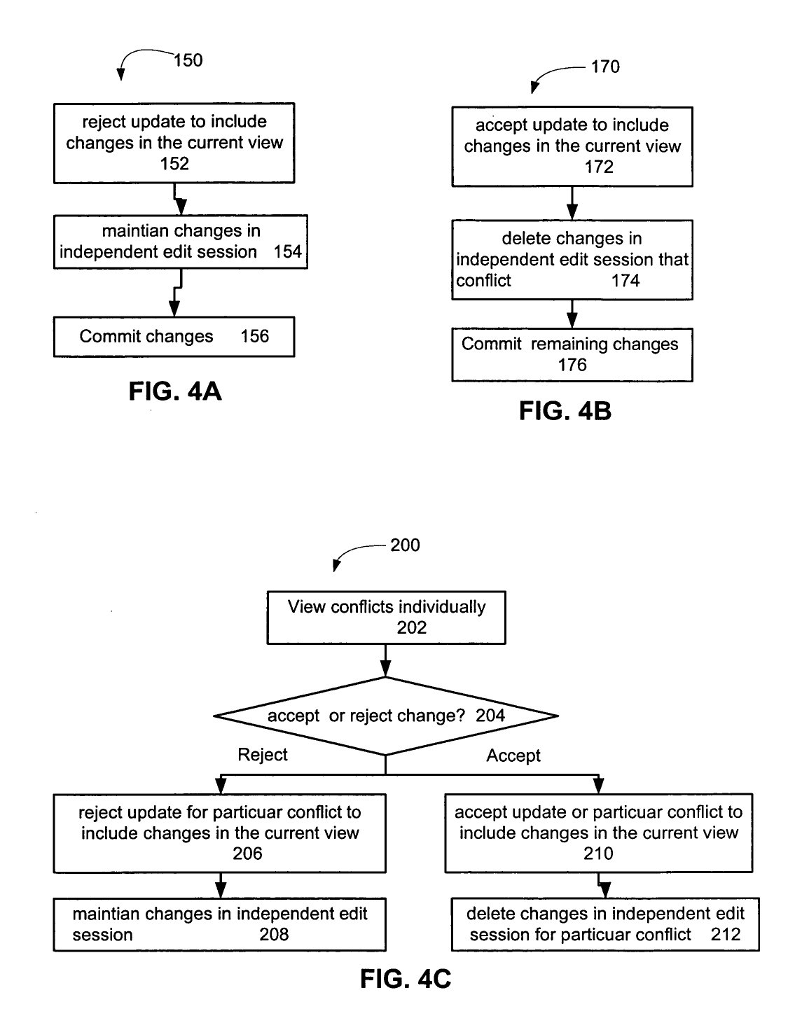

Referring to FIGS. 4A-C, various processes to resolve conflicts between the current view and the independent edit views are shown.

A process 150 for resolving conflicts by applying the independent edit view 38 of another edit session 42 is shown in FIG. 4A. Process 150 includes rejecting 152 the changes in the current view 34 that conflict with the independent edit view 38. Process 150 maintains 154 all changes in the proposed list of changes 40 entered by the user. These changes include the configuration data changes applied to the configuration database 12 that conflict with the current view 34. In order for these changes to be included in the configuration database 12, process 150 includes committing 156 the changes in the independent edit view 38 to the configuration database 12 as described above.

A process 170 for resolving conflicts by accepting the updated current view 34 is shown in FIG. 4B. Process 170 includes updating the independent edit view 38 to include changes in the current view 34. Process 170 deletes any changes in the list of changes 40 for a particular edit session 42 that conflict with the current view 34. In order to have the remaining changes in the independent edit session 42 applied to the configuration database 12, process 170 includes the user committing 176 the changes as described above in relation to FIG. 3.

A process 200 for resolving conflicts on an individual basis is shown in FIG. 4C. Process 200 allows a user to view 202 the conflicts individually. For each conflict, the user decides 204 whether to accept or reject the change. For a particular conflict, if the user decides to reject the change process 200 rejects 206 the update for the particular component that resulted in the conflict. Process 200 maintains 208 the change to the configuration data in the list of changes 40 for the independent edit session 42. On the other hand, if a user decides 204 to accept a change, process 200 accepts 210 the update of a particular component. Process 200 deletes 212 entries in the list of changes 40 for the independent edit view 42 that resulted in the conflict.

The processor described herein can be implemented in digital electronic circuitry, in computer hardware, firmware, software, or in combinations of them. The processor described herein can be implemented as a computer program product, e.g., a computer program tangibly embodied in an information carrier, e.g., in a machine-readable storage device or in a propagated signal, for execution by, or to control the operation of, data processing apparatus, e.g., a processing device, a computer, or multiple computers. A computer program can be written in any form of programming language, including compiled, assembled, or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

A number of embodiments of the invention have been described. Nevertheless, it will be understood that various modifications may be made without departing from the spirit and scope of the invention. Accordingly, other embodiments are within the scope of the following claims.

1. A method comprising:
receiving user-input configuration changes to a configuration file;
tracking the configuration changes in multiple independent edit views;
updating an active edit view to include configuration changes of a single independent edit view; and
updating a configuration database that stores the configuration file, according to the configuration changes in the active edit view.

2. The method of claim 1 further comprising checking the syntax and semantics of the active edit view before updating the configuration database.

3. The method of claim 1 further comprising updating other independent edit views based on changes in the active edit view.

4. The method of claim 1 further comprising generating a list of changes to the configuration file in the configuration database based on the updating of the configuration database.

5. The method of claim 4 further comprising identifying a conflict between an independent edit view and the list of changes.

6. The method of claim 5 wherein a conflict includes a modification to an element included in both the list of changes and the independent edit view.

7. The method of claim 5 further comprising resolving the conflict between the independent edit view and the list of changes.

8. The method of claim 7 wherein resolving the conflict includes updating the independent edit view based on the active edit view such that the independent edit view includes the changes to the configuration database.

9. The method of claim 7 wherein resolving the conflict includes discarding the changes and applying a different independent edit view to the active edit view.

10. The method of claim 7 wherein resolving the conflict includes resolving multiple conflicts on an individual basis.

11. A computer program product, tangibly embodied in an information carrier, for executing instructions on a processor, the computer program product being operable to cause a machine to:
receive user-input configuration changes to a configuration file;
track the configuration changes in multiple independent edit views;
update an active edit view to include configuration changes of a single independent edit view; and
update a configuration database that stores the configuration file, according to the configuration changes in the active edit view.

12. The computer program product of claim 11 being operable to check the syntax and semantics of the active edit view before updating the configuration database.

13. The computer program product of claim 11 being operable to update other independent edit views based on changes in the active edit view.

14. The computer program product of claim 11 being operable to generate a list of changes to the configuration file in the configuration database based on the updating of the configuration database.

15. The computer program product of claim 11 being operable to identify a conflict between an independent edit view and the list of changes.

16. The computer program product of claim 15 being operable to resolve the conflict between the independent edit view and the list of changes.

17. A system configured to:
receive user-input configuration changes to a configuration file;
track the configuration changes in multiple independent edit views;
update an active edit view to include configuration changes of a single independent edit view; and
update a configuration database that stores the configuration file, according to configuration changes in the active edit view.

18. The system of claim 17 further configured to check the syntax and semantics of the active edit view before updating the configuration database.

19. The system of claim 17 further configured to update other independent edit views based on changes in the active edit view.

20. The system of claim 17 further configured to generate a list of changes to the configuration file in the configuration database based on the updating of the configuration database.

21. The system of claim 17 further configured to identify conflicts between an independent edit view and the list of changes.

22. The system of claim 21 further configured to resolve the conflict between the independent edit view and the list of changes.
